(19) United States
(12) Patent Application Publication
(10) Pub. No.: US 2006/0141234 A1
(43) Pub. Date: Jun. 29, 2006

(54) Coated compressible substrates

(76) Inventors: Brian K. Rearick, Allison Park, PA (US); R. Preston Jones, Mars, PA (US); Deborah E. Hayes, Verona, PA (US)

Correspondence Address: PPG INDUSTRIES, INC., Intellectual Property Department, One PPG Place, Pittsburgh, PA, 15272, US

(21) Appl. No.: 11/021,325

(22) Filed: Dec. 23, 2004

(51) Int. Cl. C08K 5/16; B32B 3/26

(52) U.S. Cl. 428/304.4; 524/198

(57) ABSTRACT

Compressible substrates coated with a coating comprising an aqueous polyurethane resin having a hydroxyl number of less than 10 and a colorant are disclosed. Footwear and footwear components comprising compressible substrates coated with an aqueous polyurethane resin having a hydroxyl number of less than 10 and a colorant are also disclosed.

### FIELD OF THE INVENTION

The present invention relates to coated compressible substrates. More particularly, the invention relates to compressible materials coated with an aqueous polyurethane coating comprising an aqueous polyurethane resin having a hydroxyl number of less than 10, and a colorant.

### BACKGROUND INFORMATION

Traditional methods of adding color to polymeric olefinic foam materials, such as ethylene vinyl acetate (EVA) foams, have typically required the addition of an in-mold-colorant prior to, or during, the casting stage. Such colored foams have typically required the dispersion of a colorant throughout the foamed material.

In the footwear industry, shoe midsoles can be formed of compressible foam. Manufacturers often desire to use a colored sole and/or midsole to enhance the overall appearance of the footwear. Each sole or midsole is often produced by adding a colorant prior to, or during, the casting stage of the foam. In order to utilize colored foam soles or midsoles, footwear manufacturers typically needed to create and stock a significant inventory of shoe soles and midsoles of various color and size depending on the specifications of each product. This can create a significant warehousing difficulty and/or fabrication expense.

It is desirable to coat compressible substrates with a colored coating thereby reducing the need to maintain an inventory of these substrates. Accordingly, there is a need for a compressible material coated with a colored coating, which provides sufficient mechanical and/or visual properties.

### SUMMARY OF THE INVENTION

An embodiment of the present invention provides an article of manufacture comprising a compressible substrate and a coating on at least a portion of the compressible substrate comprising an aqueous polyurethane resin having a hydroxyl number of less than 10 and a colorant.

Another embodiment of the present invention provides a compressible substrate comprising a coating on at least a portion of the substrate, the coating comprising an aqueous polyurethane resin having a hydroxyl number of less than 10 and a colorant.

Another embodiment of the present invention provides a method of coating a compressible substrate comprising applying to at least a portion of the compressible substrate a coating composition comprising an aqueous polyurethane resin having a hydroxyl number of less than 10 and a colorant.

Yet another embodiment of the present invention provides a footwear component comprising a foam substrate having an exterior surface at least partially coated with a coating comprising a colorant.

These and other embodiments of the present invention will be more apparent from the following description.

### DETAILED DESCRIPTION

The present invention provides a compressible substrate, coated with a coating comprising an aqueous polyurethane dispersion and a colorant. It has been observed that the coatings of the present invention can be substantially flexible, such that when the coated substrate is compacted, folded, creased and/or bent, flaking, peeling and/or cracking of the coating is minimized.

As used herein, the term “compressible substrate” means a substrate capable of undergoing a compressive deformation and returning to substantially the same shape once the compressive deformation has ceased. As used herein, the term “compressive deformation” means a mechanical stress that reduces the volume, at least temporarily, of a substrate in at least one direction. Compressible substrates can be coated with coatings of the present invention on any number of exterior surfaces. Coatings can be applied to substantially all of an entire exterior surface, or any portion of any number of exterior surfaces. In certain embodiments, substantially all, i.e. 90 percent or greater, such as 95 percent or greater, of an exterior surface is coated according to the present invention; thus, these embodiments are distinguished from foam decorated with logos, designs and the like, in which a relatively small area of the exterior surface is decorated, typically in a predetermined pattern. For example, substantially all of an exterior surface that is exposed in the finished article of manufacture can be coated according to the present invention.

As used herein, the term “coating” means a material that forms a substantially continuous layer or film on a substrate. Coatings can be applied to compressible substrates to any desired thickness, such as a thickness suitable to achieve a desired mechanical property and/or visual effect. In one non-limiting embodiment, the coatings may seep into a portion of the surface of the compressible substrate, for example, into the pores of open cell foam at the exterior surface of the compressible substrate while maintaining a coating on the exterior surface of the compressible substrate.

For some applications, it may be desired to apply at least one coating directly to an exterior surface of the compressible substrate. In other applications, it may be desired to apply a primer to the exterior of the compressible surface before applying any coatings. Example primers include epoxies, epoxy polyamide, polyolefins, chlorinated polyolefins, vinyl polymers, polyurethanes, alkyds, acrylics and/or polyesters, and the like. In other applications, a protective layer such as a sealer can be applied to the exterior surface of the coatings. The sealer can provide a protective and/or visually aesthetic layer, such as a clear coat.

Coatings can be applied as a monocoat or applied as one layer in a multiple layer coating system having two or more layers in which each coat may or may not contain different components. It will be appreciated that the coatings of the present invention are sprayed onto the substrates themselves, which may or may not have other coatings applied thereto, and are not applied as a laminate nor are they applied to release paper and transferred to a substrate. Thus, the present invention can provide reduction in labor time.

In one embodiment of the present invention, the coating composition is substantially solvent-free. The term “substantially solvent-free” as used herein means that the coating composition contains less than about 15 or 20 weight percent organic solvents, preferably less than 5 or 10 weight percent, with weight percent being based on the total weight of the coating composition to be applied to the substrate. For example, the coating composition may contain from zero to 2 or 3 weight percent organic solvents.

The term “aqueous” as used herein means coating compositions in which the carrier fluid of the composition is predominantly water on a weight percent basis, i.e., more than 50 weight percent of the carrier comprises water. The remainder of the carrier comprises less than 50 weight percent organic solvent, typically less than 25 weight percent, preferably less than 15 weight percent. Based on the total weight of the coating composition (including the carrier and solids), the water may comprise from about 20 to about 80 weight percent, typically from about 30 to about 70 weight percent, of the total composition.

The coatings used according to the present invention can comprise a polyurethane dispersion. Any polyurethane resin that forms a suitable film, and is compatible with aqueous compositions, can be used in accordance with the present invention, absent compatibility problems. Suitable polyurethane resins include those formed from a polyisocyanate, an active hydrogen-containing material, such as a polyol, a polyether, a polyester, a polycarbonate, a polyamide, a polyurethane, a polyurea, a polyamine, a polyolefin, a siloxane polyol, and/or mixtures thereof, an acid functional material having a functional group reactive with isocyanate and optionally a polyamine. Examples of acid functional materials include dimethyl propionic acid and butanoic acid. Some example resins that may be suitable for use in the present coating compositions are described in U.S. Pat. No. 5,939,491, which is incorporated by reference herein.

In one non-limiting embodiment, the polyurethane has a molecular weight average of at least 10,000, such as at least 25,000, such as 100,000 or higher. The polyurethane resin in certain embodiments has a hydroxyl number of less than about 10, such as less than about 5, such as less than about 3. The film-forming polyurethane resin is generally present in the coating in an amount greater than about 20 weight percent, such as greater than about 40 weight percent, and less than 90 weight percent, with weight percent being based on the total solid weight of the cured coating. For example, the weight percent of resin can be between 20 and 80 weight percent.

In one non-limiting embodiment, di and/or trifunctional acrylics, polyesters, polyethers, polycarbonates, polyamides, epoxies and/or vinyls can be added as a partial replacement for a portion of the polyurethane dispersion. Suitable di and/or trifunctional acrylic resins can include unsaturated acrylic monomers and/or copolymers with vinyl monomers prepared through emulsion polymerization. Suitable polyester resins can include reaction products of polyfunctional acid anhydrides, polyfunctional alcohols and monofunctional acids and alcohols. Other suitable resins include hybrids or mixtures of any of these resins, for example, acrylic/polyurethane and/or acrylic/polyester hybrids and/or blends.

The coatings of the present invention also include a colorant. As used herein, the term “colorant” means any substance that imparts color and/or other opacity and/or other visual effect to the composition. The colorant can be added to the coating in any suitable form, such as discrete particles, dispersions, solutions and/or flakes. A single colorant or a mixture of two or more colorants can be used in the coating of the present invention.

Example colorants include pigments, dyes and tints, such as those used in the paint industry and/or listed in the Dry Color Manufacturers Association (DCMA) as well as special effect compositions. A colorant may include, for example, a finely divided solid powder which is insoluble but wettable under the conditions of use. A colorant can be organic or inorganic and can be agglomerated or non-agglomerated.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black and mixtures thereof. The term pigment and colored filler can be used interchangeably.

Example dyes include, but are not limited to, those which are solvent and/or aqueous based such as pthalo green or blue, iron oxide, bismuth vanadate, anthraquinone, perylene, aluminum and quinacridone.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above the colorant can be in the form of a dispersion including, but not limited to, a nanoparticle dispersion. Nanoparticle dispersions can include one or more highly dispersed nanoparticle colorants or colorant particles that produce a desired visible color and/or opacity and/or visual effect. Nanoparticle dispersions can include colorants such as pigments or dyes having a particle size of less than about 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Application Publication No. 2003/0125417, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in U.S. application Ser. No. 10/876,315 filed Jun. 24, 2004, which is incorporated herein by reference, and U.S. Provisional Application No. 60/482,167 filed Jun. 24, 2003, which is also incorporated herein by reference.

Example special effect compositions that may be used in the coating of the present invention include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as opacity or texture. In a non-limiting embodiment, special effect compositions can produce a color shift, such that the color of the coating changes when the coating is viewed at different angles. Example color effect compositions are identified in U.S. Patent Application Publication No. 2003/0125416, incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In certain non-limiting embodiments, a photosensitive composition and/or photochromic composition, which reversibly alters its color when exposed to one or more light sources, can be used in the coating of the present invention. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. In one non-limiting embodiment, the photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

In a non-limiting embodiment, the photosensitive composition and/or photochromic composition can be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with a non-limiting embodiment of the present invention, have minimal migration out of the coating. Example photosensitive compositions and/or photochromic compositions and methods for making them are identified in U.S. application Ser. No. 10/892,919 filed Jul. 16, 2004 and incorporated herein by reference.

In general, the colorant can be present in the coating composition in any amount sufficient to impart the desired visual and/or color effect. The colorant may comprise from 1 to 65 weight percent of the present compositions, such as from 3 to 40 weight percent or 5 to 35 weight percent, with weight percent based on the total weight of the compositions.

The present coating compositions may also optionally include other ingredients such as cross-linkers, extenders, ultra-violet (UV) absorbers, light stabilizers, plasticizers, surfactants, leveling agents, adhesion promoters, rheology modifiers, hindered amine light stabilizers (HALS), and wetting agents in a total amount of up to 80 weight percent based on the total solid weight percent of the coating composition to be applied to the substrate. Suitable cross-linkers include carbodiimides, azidines, melamines, bisoxazolidine, acid-catalyzed formaldehydes, and/or isocyanates. Water-based carbodiimides may be preferred in some applications because they do not contribute a significant amount of organic solvents to the coating composition. When a cross-linker is used, it is generally present in an amount of up to about 50 weight percent, based on the total solid weight of the cured coating.

Additional optional coating additives include odor effect compositions, which impart a desired odor to the coating and/or limit undesired odors from developing over time. Example odor effect compositions can include fragrance additives, such as perfumes and/or colognes, and/or odor masking compositions, such as deodorants. In a non-limiting embodiment, the odor effect composition can comprise additives that produce or emit the smell of new leather.

Other suitable coating components include one or more texture-enhancers that improve the surface feel and/or that enhance stain resistance of the coating. In one non-limiting embodiment, the texture-enhancer imparts a soft feel to the coating. As used herein, the term “soft feel” means the coated substrate exhibits an altered tactile property such as a simulated velvet or leather tactile feel when touched. The texture-enhancer can be an additive that can be added to the coating composition such as silica flattening agents and/or wax additives. Example silica flattening agents can include ACEMATT OK 412 and ACEMATT TS 100 commercially available from Degussa, Inc. Example wax additives can include polytetraethylene oxide, fluorinated waxes, polyethylene waxes, or natural waxes such as paraffin and/or carnauba wax. In another non-limiting embodiment, the texture-enhancer can be incorporated within the polyurethane resin itself. For example, components that will impart a larger “soft-segment” to the polyurethane can be used. Examples include polytetramethylene ether glycol commercially available under the name TERATHANE 2000 from Invista, Inc.

Example compressible substrates include foam substrates, polymeric bladders filled with liquid, polymeric bladders filled with air and/or gas, and/or polymeric bladders filled with plasma. As used herein the term “foam substrate” means a polymeric or natural material that comprises a open cell foam and/or closed cell foam. As used herein, the term “open cell foam” means that the foam comprises a plurality of interconnected air chambers. As used herein, the term “closed cell foam” means that the foam comprises a series of discrete closed pores. Example foam substrates include polystyrene foams, polymethacrylimide foams, polyvinylchloride foams, polyurethane foams, polypropylene foams, polyethylene foams, and polyolefinic foams. Example polyolefinic foams include polypropylene foams, polyethylene foams and/or ethylene vinyl acetate (EVA) foam. EVA foam can include flat sheets or slabs or molded EVA forms, such as shoe midsoles. Different types of EVA foam can have different types of surface porosity. Molded EVA can comprise a dense surface or “skin”, whereas flat sheets or slabs can exhibit a porous surface.

The coatings of the present invention can be applied to the compressible substrate by any conventional coating application means. Example coating application means include spraying, slot coating, roll coating, curtain coating, dipping, screen printing, brushing or rod coating. In some embodiments, the coating is applied to substantially all of an entire exterior surface of the compressible substrate. In other embodiments, the coating is applied to a portion of an exterior surface of the compressible substrate.

In one non-limiting embodiment, an article of manufacture may comprise any manufactured or fabricated product comprising a compressible substrate. In a non-limiting embodiment, the article of manufacture can comprise footwear and/or a footwear component. As used herein, the term “footwear” includes shoes, including athletic and sport shoes, men's and women's dress shoes, men's and women's casual shoes, children's shoes, sandals, including flip-flops, boots, including work boots, outdoor footwear, orthopedic shoes, slippers and the like. As used herein, the term “footwear component” includes any part or portion of footwear including a compressible substrate. Example footwear components include soles, midsoles, upper materials and liners. Midsoles and soles can comprise an ethylene vinyl acetate foam.

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. As used herein, the singular forms of “a”, “an” and “the” include plural referents. Accordingly, while the invention has been described in terms of “an” aqueous polyurethane and “a” colorant, one or more aqueous polyurethanes and/or colorants can be used. Similarly, any number or combination of other components described herein can be used according to the present invention. Also, as used herein, the term “polymer” is meant to refer to prepolymers, oligomers and both homopolymers and copolymers; the prefix “poly” refers to two or more.

### EXAMPLES

The following examples are intended to illustrate various aspects of the present invention and are not intended to limit the disclosure or claims of the invention.

### Example 1

Sample Coatings 1-7 were prepared by mixing the components shown in Table 1.

TABLE 1

| | Sample | Sample | Sample | Sample | Sample | Sample | Sample |
|---|---|---|---|---|---|---|---|
| | 1 (g) | 2 (g) | 3 (g) | 4 (g) | 5 (g) | 6 (g) | 7 (g) |
| Polyurethane Dispersion 1 | 81.75 | — | — | — | — | — | — |
| Polyurethane Dispersion 2 | — | 83.27 | 69.49 | 53.33 | 52.41 | 56.31 | 59.75 |
| Carbodiimide Crosslinker¹ | 14.60 | 16.03 | 18.87 | 14.47 | 14.23 | 14.37 | 15.25 |
| Polyurethane Dispersion 3 | 0.50 | 0.70 | — | — | — | — | — |
| Defoamer² | 0.25 | 0.70 | — | — | — | — | — |
| White Tint³ | — | — | — | 26.20 | 15.14 | — | — |
| Blue Tint⁴ | — | — | — | — | 6.09 | — | — |
| Green Tint⁵ | — | — | — | — | 0.64 | — | — |
| Red Tint⁶ | — | — | — | — | — | 23.56 | 25.00 |
| Black Tint⁷ | — | — | — | — | — | — | — |
| Solvent⁸ | 1.00 | — | — | — | — | — | — |
| DI Water | 1.90 | — | 11.64 | 6.00 | 11.29 | 5.76 | — |
| Equivalent Ratio PU:Crosslinker | 1.0:1.0 | 1.0:1.0 | 1.0:1.0 | 1.0:1.0 | 1.0:1.0 | 1.0:1.0 | 1.0:1.0 |

¹CARBODILITE V02-L2, from Nisshinbo Chemicals
²Air Products MD-20 Defoamer
³OneSource, 9292-T1467 white tint, from PPG Industries, Inc.
⁴OneSource, 9292-L8843 blue tint, from PPG Industries, Inc.
⁵OneSource, 9292-G9463 green tint, from PPG Industries, Inc.
⁶OneSource, 9292-R3817 red tint, from PPG Industries, Inc.
⁷OneSource, 9292-B3546 lamp black tint, from PPG Industries, Inc.
⁸DOWANOL PM, from Dow Chemical, from PPG Industries, Inc.

Polyurethane Dispersion 1

Polyurethane dispersion 1 was made by charging a reaction vessel equipped with stirrer, thermocouple, condenser and nitrogen inlet with 1010.3 g polytetramethylene ether glycol sold under the designation TERATHANE 2000, and 50.7 g dimethylolpropionic acid and heated to 60° C. 336.7 g isophorone diisocyanate was added over 10 minutes followed by 356.2 g methyl ethyl ketone and 1.51 g dibutyltin dilaurate. The reaction exothermed to 63° C. The reaction temperature was raised to 80° C. and the contents were stirred until the isocyanate equivalent weight was 1380. Then 39.4 g dimethylolpropionic acid was added to the reaction flask. The contents were stirred until the isocyanate equivalent weight was 2094.

The resultant product had a solids content of 83.4 weight percent (measured for one hour at 110° C.), an acid value of 21.20 mg KOH/g and a weight average molecular weight of 14971 in THF.

1552.0 g of above prepolymer at 76° C. was added over 25 minutes to a solution of 2259.9 g de-ionized water, 40.6 g adipid acid dihydrazide and 52.2 g dimethyl ethanol amine stirring at 21° C. and at 500 rpm in a cylindrical gallon reaction flask equipped with baffles, double pitched bladed stirrer, thermocouple and condenser. The dispersion temperature after this addition was 36° C. The reaction contents were stirred until no evidence of isocyanate was observed by FTIR.

This dispersion was transferred to a flask equipped with a stirrer, thermocouple, condenser and a receiver. The dispersion was heated to 60° C. and methyl ethyl ketone and water was removed by vacuum distillation.

The final dispersion has a solids content of 38.7 weight percent (measured from one hour at 110° C.), a Brookfield viscosity of 144 centipoise using a #2 spindle at 60 rpm, an acid content of 0.171 meq acid/g, a base content of 0.177 meq base/g, a pH of 8.26, a residual methyl ethyl ketone content of 0.15 weight percent and a weight average molecular weight of 95536 in DMF.

Polyurethane Dispersion 2

Polyurethane dispersion 2 was made by charging a reaction vessel equipped with stirrer, thermocouple, condenser and nitrogen inlet with 1447.3 g polytetramethylene ether glycol having a molecular weight of about 1,000 sold under the designation TERATHANE 1000, 145.4 g dimethylolpropionic acid and heated to 60° C. 965.3 g isophorone diisocyanate was added over 13 minutes followed by 637.5 g methyl ethyl ketone and 4.34 g dibutyltin dilaurate. The reaction exothermed to 72° C. The reaction temperature was raised to 80° C. and the contents were stirred until the isocyanate equivalent weight was 923.5. Then 114.0 g dimethylolpropionic acid was added to the reaction flask. The contents were stirred until the isocyanate equivalent weight was 1430.2.

1512.2 g of the above prepolymer at a temperature of 75° C. was then added over a 16 minutes span to a solution of 2201.9 g deionized water, 58 g adipic acid dihydrazide and 76.2 dimethyl ethanol amine stirring at a temperature of 25° C. and 515 rpm in a cylindrical gallon reaction flask equipped with baffles, double pitched bladed stirrer, thermocouple and condenser. The dispersion temperature after this addition was 40° C. The reaction contents were stirred until no evidence of isocyanate was observed by FTIR. This dispersion was transferred to a flask equipped with a stirrer, thermocouple, condenser and a receiver. The dispersion was heated to 50° C. and methyl ethyl ketone and water were removed by vacuum distillation.

The final polyurethane dispersion had a solids content of 37.48 weight percent (measured for one hour at 110° C.), a Brookfield viscosity of 1450 centipoise using a #3 spindle at 60 rpm, an acid content of 0.240 meq acid/g, a base content of 0.247 meq base/g, a residual methyl ethyl ketone content of 1.16 weight percent and a weight average molecular weight of 77274 in DMF.

Polyurethane Dispersion 3

Polyurethane dispersion 3 was produced by serially adding the following ingredients and mixing: 35 parts by weight DISPERCOLL E585 polyurethane resin having 40 weight percent ionic dispersed polyurethane resin in water, commercially available from Bayer Corporation; 16 parts by weight RHOPLEX VA 2113 polyvinylacetate latex having 55 weight percent polyvinylacetate latex in water, commercially available from Rohm and Haas; 7 parts by weight PLASTHALL BSA butyl benzene sulfonamide plasticizer, commercially available from The C.P. Hall Company; 1 part by weight XAMA2 trimethyolpropanetris-(B-(N-aziridinyl)propionate), commercially available from Virginia Chemicals; 2 parts by weight carbodiimide; 1 part by weight propylene glycol; and 0.5 parts by weight RHOPLEX QR 708 thickener, commercially available from Rohm and Haas.

Samples 1-7 were prepared in the following manner. Polyurethane dispersion 1 or 2 was agitated using a pneumatic rotary air stirrer and a low-lift impeller blade. Additive amounts, as specified in Table 1, were serially added under agitation. The mixture was filtered through 18 TXX polyester multifilament mesh into a clean receptacle. The resulting coatings was allowed to equilibrate for approximately 24 hours prior to application.

Samples 1 and 2 identified in Table 1 were spray-applied to EVA foam using a DEVILBISS SRI-625 HVLP gravity hand spray gun at 29 psi inlet pressure/10 psi air cap. The coating was applied to a dry film thickness of 10-50 microns. Samples 3-7 were spray-applied to EVA foam using a Binks Model 7 suction feed gun at 40 psi. The EVA foam coated with Samples 1 and 2 were flashed for 10 minutes at ambient temperature then cured for 10 minutes at 140° F. EVA foam coated with Samples 5-slab, 6 and 7 were flashed for 10 minutes at ambient temperature and cured for 5 minutes at 180° F. EVA foam coated with Sample 5-molded shoe midsole was flashed for 20 minutes at ambient temperature and cured for 5 minutes at 180° F.

The coated EVA foam was then tested to determine the initial adhesion according to ASTM Standard D3359. Adhesion was measured on a scale of 1-5, with 1 being total loss of adhesion and 5 being no loss of adhesion. The coating was also applied to EVA foam and placed in a humidity test chamber calibrated at 100% relative humidity at 100° F. for 10 days according to ASTM Standard D2247-99. The coated foam was removed from the humidity chamber and tested for post-humidity adhesion according to ASTM D3359. Post humidity adhesion was measured on a the same 1-5 scale. The coated foam was also tested for post humidity blistering according to ASTM Standard D714. Post humidity blistering was measured on a scale of 0-10 with a blistering frequency of Dense (D), Medium Dense (MD), Medium (M), Few (F), Very Few (VF) and None (N). The 0-10 scale refers to the size of the blisters wherein 10 is no blistering, 9 is blistering visible with a microscope, 8 is blistering visible to the naked eye and progressively getting larger as the number reaches 0.

The coating was also applied to EVA foam and manually flexed at a 180° angle in a backwards and forwards direction for approximately one minute. Change in appearance, including the crack severity, was visually evaluated. The results of the above-described tests are shown in Table 2.

TABLE 2

| Coating | EVA Foam | Initial | Post Humidity | Post Humidity | |
|---|---|---|---|---|---|
| Sample | Type | Adhesion | Adhesion | Blistering | Flexibility |
| Sample 1 | Sheet | 5 | 5 | 8VF | No visual |
| | | | | | coating |
| | | | | | cracking, loss |
| | | | | | of adhesion |
| | | | | | or change in |
| | | | | | appearance |
| Sample 2 | Sheet | 5 | 4 | 8VF | No visual |
| | | | | | coating |
| | | | | | cracking, loss |
| | | | | | of adhesion |
| | | | | | or change in |
| | | | | | appearance |
| Sample 5 | Sheet | 5 | — | — | No visual |
| | | | | | coating |
| | | | | | cracking, loss |
| | | | | | of adhesion |
| | | | | | or change in |
| | | | | | appearance |
| Sample 5 | Molded Shoe | 5 | — | — | No visual |
| | Midsole | | | | cracking, loss |
| | | | | | of adhesion |
| | | | | | or change in |
| | | | | | appearance |
| Sample 6 | Molded Shoe | 5 | — | — | No visual |
| | Midsole | | | | cracking, loss |
| | | | | | of adhesion |
| | | | | | or change in |
| | | | | | appearance |
| Sample 7 | Molded Shoe | 5 | 5 | — | No visual |
| | Midsole | | | | cracking, loss |
| | | | | | of adhesion |
| | | | | | or change in |
| | | | | | appearance |

### Example 2

Commercially available flip-flops made of EVA foam were partially coated with the coatings of Samples 1, 2, 3 and 4 of Example 1; a portion of the flip flop was coated with the sample coating and the remainder left uncoated. The flip-flops coated with Sample 1 exhibited a “soft-feel” tactile property when touched.

The flip-flops coated with Samples 1, 3 and 4 were experimentally tested by wearing them for two consecutive weeks for a period of 6-7 hours a day. In each case, the portion of the flip-flop that was coated with a Sample coating was notably cleaner than the uncoated portion. Less dirt adhered to the portion of the flip-flop coated with the Sample coatings than the portions that were left uncoated. The portions of the flip-flops coated with Samples 3 and 4 did not show any loss of adhesion and the coating maintained its integrity after wearing, however, a series of micro-cracks having a size of less than 2 mm developed in some areas. The portion of the flip-flops coated with Sample 1 did not show any loss of adhesion, maintained coating integrity and did not develop visible micro-cracks.

### Example 3

Sections of commercially available off-the-shelf DADA brand shoes were masked-off with tape. The EVA foam midsoles were cleaned with isopropyl alcohol and the coating of Sample 4 was spray applied according to the procedure of Example 1 using the DEVILBISS gun, and cured at 140° F. for 10 minutes to a dry film thickness of 1-2 mils. The shoes were experimentally tested by wearing them for a period of 3 months from summer to early fall on a nearly daily basis. The sections of the shoes that were coated with the coating of Sample 4 were visually cleaner than the un-coated sections. The coating maintained adhesion and coating integrity.

After three months of wear, one shoe was placed into a standard residential washing machine and washed with laundry detergent. The washed shoe also maintained coating integrity and adhesion in the coated sections. The coated sections of the washed shoe were visually cleaner than the coated sections of the unwashed shoe.

### Example 4

EVA foam coated with the coating of Sample 7 was sent to a shoe-manufacturing facility where it was incorporated into a prototype shoe. In this example, the coating of Sample 7 was applied directly to the EVA foam substrate, using the DEVILBISS gun and cured at 140° F. for 10 minutes. The coated EVA foam withstood the rigors of the shoe-fabrication process without showing any visual loss of adhesion, loss of coating integrity, cracking or peeling.

### Example 5

The previously uncoated EVA midsoles of two DADA shoes were coated with two different formulations of tinted polyurethane dispersions. The first formulation was produced by adding 10 g of aluminum tint paste under slow agitation to a premixture of 73 g of polyurethane dispersion 2 and 17 g of carbodiimide.

The second formulation was produced by adding 50 g of blue nano-pigment dispersed polyurethane acrylic colorant to a premixture of 37.0 g of polyurethane dispersion 2 and 9.0 g of carbodiimide. The blue nano-pigment dispersed acrylic colorant was produced by making a pre-emulsion by stirring charge A, as identified in Table 3, with a Cowles blade in a stainless steel beaker. The pre-emulsion was then recycled through a MICROFLUIDIZER M110T at 8,000 psi for 15 minutes and transferred to a four neck round bottom flask equipped with an overhead stirrer, condenser, electronic temperature probe, and a nitrogen atmosphere. Charge B, as identified in Table 3, was used to rinse the MICROFLUIDIZER and was added to the flask. The temperature of the microemulsion was adjusted to 30° C. The polymerization was initiated by adding Charge C, as identified in Table 3, followed by a 30 minute addition of Charge D, also identified in Table 3. The temperature of the reaction increased to 56° C. The final pH of the latex was 7.24, the nonvolatile content was 35.9%, the Brookfield viscosity was 87 cps.

TABLE 3
Blue Nano-Pigment Dispersed Polyurethane Acrylic Coating

| Charge A | | |
|---|---|---|
| Pigment Dispersion¹ including Acrylic² | 138.0 | g |
| Polyurethane/urea Pre-polymer³ | 428.6 | g |
| Methyl methacrylate | 120.0 | g |
| Monobutyl ether of propylene glycol | 90.0 | g |
| Charge B | | |
| Water | 40.0 | g |
| Charge C | | |
| Sodium metabisulfite | 0.6 | g |
| Ferrous ammonium sulfate | 0.1 | g |
| Water | 10.0 | g |
| Charge D | | |
| 70% t-butyl hydroperoxide | 0.6 | g |
| Water | 10.0 | g |
| ¹Pigment dispersion was prepared by mixing 45.0 g of Acrylic², 473.0 g deionized water, 45.0 g of phthalo blue at 2% solid weight, and 1800.0 g glass beads having a mean diameter of 71 microns, commercially available from Potters Glass, Inc. The mixture was milled at 5,000 rpm for 6 hours. The progress of the milling was monitored by measuring | | |
| # the visible spectra of samples and observing the decrease in absorbance at a wavelength of 400 nm. During the course of the milling, 200 g of additional water was added as needed to offset the increasing viscosity of the mixture. The mixture was filtered through a 1 micron felt bag to remove the glass beads. The product | | |
| # has a non-volatile content of 7.58%. | | |
| ²Acrylic was produced by mixing 20.0 g magnesol and 120.0 g toluene in a 2 liter flask with air-stirrer, thermocouple and azeotropic distillation set-up. The mixture was heated to reflux and water was azeotroped off. The mixture was then cooled and put under a nitrogen blanket. 7.5 g of 2,2′-dipyridyl and 6.1 g of copper (0) powder were added to | | |
| # the mixture while maintaining the nitrogen blanket. 30.4 g para-toluenesulfonyl chloride was also added to the mixture while maintaining the nitrogen blanket. 169.2 g benzylmathacrylate and 20.0 g glycidyl isopropyl ether were added to an addition funnel and sparged with nitrogen for 15 minutes prior to addition. The 169.2 | | |
| # g benzylmathacrylate and 20.0 g glycidyl isopropyl ether was then added to the reaction flask and the mixture was heated carefully to 70° C. When the solids reached 60.7%, 888.3 g MPEG(550)MA and 250.0 g toluene were charged to an addition funnel and sparged with nitrogen for 15 minutes. The 888.3 g MPEG(550)MA and 250.0 g toluene were then added to the | | |
| # reaction over 30 minutes while maintaining a 70° C. reaction temperature. The reaction was heated for 6 hours and then cooled and stirred overnight under a nitrogen blanket. The reaction mixture was thinner with 500 g of toluene and then filtered through a cake of magnesol to remove the residual catalyst. The solvent | | |
| # was removed under vacuum yielding a resin at 98.4% solids. | | |
| ³Polyurethane/urea pre-polymer was produced in a four neck round bottom flask equipped with an electronic temperature probe, mechanical stirrer, condenser, and a heating mantle. 269.8 g N-methyl-pyrrolidinone, 91.1 g hydroxyethyl methacrylate (HEMA), 234.7 g dimethylolpropionic acid (DMPA), 2.2 g triphenyl phosphite, 2.2 g dibutyltin dilaurate and 2.2 | | |
| # g butylated hydroxytoluene were stirred in the flask at a temperature of 100° C. until all solids were dissolved. 700.0 g poly(butylene oxide) having a number average molecular weight of 1000 was added and the mixture was cooled to 70° C. 1,100.4 g 4,4′-methylenebis(cyclohexyl isocyanate) was added over a 15 | | |
| # minute period. 481.8 g butyl methacrylate was used to rinse the addition funnel containing the isocyanate and the temperature of the mixture was then held at 90° C. for an additional 3 hours. 642.5 g butyl acrylate was added over a ten minute period. The resulting composition was identified as Charge A. In a separate flask, 4,263.3 g water, 124.7 g | | |
| # dimethylethanolamine, 73.6 g diethanolamine and 42.1 g ethylenediamine were heater to 60° C. The resulting composition was identified as Charge B. Charge A was added to Charge B and the resulting mixture was cooled to room temperature. The final product was a white emulsion with an acid value of 15.2, a Brookfield viscosity | | |
| # of 800 centipoise, a pH of 7.37, and a nonvolatile content of 28.4%. | | |

Each of the formulations was spray applied to the EVA foam midsoles, as described in Example 2, using the DEVILBISS gun and cured at 140° F. for 10 minutes and evaluated to determine adhesion and blistering. As shown in Table 4, the results were excellent, although sag was an issue and, accordingly rheology optimization was initiated.

TABLE 4

| | | | Post Humidity |
|---|---|---|---|
| | | | 10 Days |
| | Shoe | Initial | Adhesion/ |
| Formulation | Substrate | Adhesion | Blistering |
| Aluminum Tint Paste | EVA foam | 5 | 5/10 |
| Formulation | sheet | | |
| Blue Nano-Pigment | EVA foam | 5 | 5/10 |
| Dispersed Polyurethane | sheet | | |
| Acrylic | | | |

### Example 6

A coating composition was made by mixing 47.49 g of polyurethane dispersion 2 with 12.40 g CARBODILITE V02-L2, and 40.11 g of photochromic urethane acrylate in a beaker. The photochromic urethane acrylate was produced by adding the ingredients shown in Table 5 in the order described to a four neck round bottom flask equipped with an electronic temperature probe, mechanical stirrer, condenser and a heating mantle.

TABLE 5
Photochromic urethane acrylate

| Charge A | | |
|---|---|---|
| Toluene | 18.33 | g |
| Blue Photochromic dye¹ | 3.03 | g |
| Dibutyltin dilaurate | 0.01 | g |
| Butylated hydroxytoluene | 0.01 | g |
| Charge B | | |
| Composition D² | 6.6 | g |
| Charge C | | |
| Composition E³ | 2.69 | g |
| Charge D | | |
| Toluene | 4.0 | g |

¹Blue photochromic dye 3,3-di(4-methoxyphenyl)-6,11,13-trimethyl-13-(2-(2-(2-hydroxyethoxy)ethoxy)ethoxy)-3H,13H-indeno[2,1-f]naphthp[1,2-b]pyran
²2-heptyl-3,4-bis(9-isocyanatonyl)-1-pentyl-cyclohexane
³2-(dicaprolactone)ethyl acrylate

Charge A was stirred in the flask and heated to a temperature of 90° C. for 30 minutes. Charge B was added to the mixture and the mixture was held at 90° C. for 60 minutes. Charges C and D were added and the mixture was held at 90° C. for 30 minutes. The photochromic urethane acrylate was a dark blue liquid with a nonvolatile content of 53.4%, measured at 110° C. for one hour.

The final composition was blended with a low lift impeller blade attached to an air driven rotary stirrer. The polyurethane dispersion and carbodiimide were blended as a 40:60 ratio. Mixing was performed for five minutes under low to medium speed. The mixture was filtered through 18 TXX polyester multifilament mesh into a clean receptacle.

The coating composition was spray applied to EVA foam substrates as described in Example 2. The coated substrates exhibited good adhesion and acceptable fade-back when an applied light source was removed from the coating.

Whereas particular embodiments of this invention have been described above for purposes of illustration, it will be evident to those skilled in the art that numerous variations of the details of the present invention may be made without departing from the invention as defined in the appended claims.

1. An article of manufacture comprising:
a compressible substrate; and
a coating on at least a portion of the compressible substrate comprising an aqueous polyurethane resin having a hydroxyl number of less than 10, and a colorant.

2. The article of manufacture of claim 1, wherein the hydroxyl number is less than 5.

3. The article of manufacture of claim 1, wherein the polyurethane has a molecular weight of at least 10,000.

4. The article of manufacture of claim 1, wherein the coating is substantially solvent-free.

5. The article of manufacture of claim 1, wherein the colorant comprises a special effect composition.

6. The article of manufacture of claim 5, wherein the special effect composition includes a photosensitive composition and/or a photochromic composition.

7. The article of manufacture of claim 6, wherein the photosensitive composition and/or photochromic composition is associated with a polymer and/or polymeric material of a polymerizable component.

8. The article of manufacture of claim 6, wherein the photosensitive composition and/or photochromic composition is at least partially bound to a polymer and/or polymeric material of a polymerizable component.

9. The article of manufacture of claim 1, wherein the colorant produces a metallic sheen.

10. The article of manufacture of claim 1, wherein the coating further comprises a texture-enhancer.

11. The article of manufacture of claim 1, wherein the coating further comprises a carbodiimide cross-linker.

12. The article of manufacture of claim 1, wherein the coating further comprises an odor effect composition.

13. The article of manufacture of claim 1, wherein the compressible substrate comprises open cell and/or closed cell foam.

14. The article of manufacture of claim 1, wherein the compressible substrate comprises olefinic foam.

15. The article of manufacture of claim 14, wherein the olefinic foam comprises ethylene vinyl acetate foam.

16. The article of manufacture of claim 1, wherein the article of manufacture is footwear and/or a footwear component.

17. A compressible substrate comprising a coating on at least a portion of the substrate, the coating comprising an aqueous polyurethane resin having a hydroxyl number of less than 10 and a colorant.

18. The compressible substrate of claim 17, wherein the polyurethane has a molecular weight of at least 10,000.

19. The compressible substrate of claim 17, wherein the coating is substantially solvent-free.

20. The compressible substrate of claim 17, wherein the colorant comprises a special effect composition.

21. The compressible substrate of claim 20, wherein the special effect composition includes a photosensitive composition and/or a photochromic composition.

22. The compressible substrate of claim 17, wherein the colorant produces a metallic sheen.

23. The compressible substrate of claim 17, wherein the coating further comprises a texture-enhancer.

24. The compressible substrate of claim 17, wherein the coating further comprises a carbodiimide cross-linker.

25. The compressible substrate of claim 17, wherein the coating further comprises an odor effect composition.

26. The compressible substrate of claim 17, wherein the compressible substrate comprises open cell and/or closed cell foam.

27. The compressible substrate of claim 17, wherein the compressible substrate comprises olefinic foam.

28. The compressible substrate of claim 27, wherein the olefinic foam comprises ethylene vinyl acetate foam.

29. The compressible substrate of claim 17, wherein the compressible substrate is a footwear component.

30. A method of coating a compressible substrate, comprising applying a coating composition comprising an aqueous polyurethane resin having a hydroxyl number of less than 10 and a colorant to at least a portion of the compressible substrate.

31. The method of claim 30, further comprising applying a primer layer directly to an exterior surface of the compressible substrate prior to applying the coating composition.

32. The method of claim 30, further comprising applying a protective layer over at least a portion of the coating composition.

33. The method of claim 30, wherein the compressible substrate comprises open cell and/or closed cell foam.

34. A footwear component, comprising a foam substrate having an exterior surface at least partially coated with a coating comprising a colorant.

35. The footwear component of claim 34, wherein the coating comprises a polyurethane dispersion.

36. The footwear component of claim 34, wherein the coating is substantially solvent-free.

37. The footwear component of claim 34, wherein the foam substrate comprises olefinic foam.

38. The footwear component of claim 37, wherein the olefinic foam comprises ethylene vinyl acetate.

39. The article of manufacture of claim 1, wherein the colorant is in the form of a nanoparticle dispersion.

40. The compressible substrate of claim 17, wherein the colorant is in the form of a nanoparticle dispersion.

41. The footwear component of claim 34, wherein the colorant is in the form of a nanoparticle dispersion.

42. The article of manufacture of claim 1, wherein the coating is applied to substantially all of an entire external surface of the compressible substrate.

43. The compressible substrate of claim 17, wherein the coating is applied to substantially all of an entire external surface of the compressible substrate.

44. The footwear component of claim 34, wherein the coating is applied to substantially all of the exterior surface that is exposed when the footwear component is assembled into footwear.

45. The footwear component of claim 34, wherein the coating comprises an aqueous polyurethane resin that is cross-linked upon curing.
